(19) United States
(12) Patent Application Publication
(10) Pub. No.: US 2016/0178739 A1
(43) Pub. Date: Jun. 23, 2016

(54) RADAR SYSTEM FOR VEHICLE AND OPERATING METHOD THEREOF

(71) Applicant: HYUNDAI MOBIS Co., Ltd., Yongin-si (KR)

(72) Inventor: Hee Deok LEE, Yongin-si (KR)

(73) Assignee: HYUNDAI MOBIS Co., Ltd., Yongin-si (KR)

(21) Appl. No.: 14/956,989

(22) Filed: Dec. 2, 2015

(30) Foreign Application Priority Data
Dec. 19, 2014 (KR) 10-2014-0184736

(51) Int. Cl. G01S 13/04; G01S 7/41

(52) U.S. Cl. CPC G01S 13/04; G01S 7/41

(57) ABSTRACT

A radar system for a vehicle, including a radar which is located around the principal vehicle to detect a target vehicle which threatens driving of the principal vehicle as a target. The radar includes: a transmission antenna which transmits a signal for detecting the target vehicle; a reception antenna which receives a reflective signal for the transmitted signal; a communication module which transmits a high frequency signal through the transmission antenna; a converting unit which converts the reception signal which is received through the reception antenna into a digital signal; and a signal processing unit which generates a detection signal to detect the target vehicle, in accordance with a speed, a yaw rate of the principal vehicle and the digital signal, applies the detection signal to the communication module, and analyzes the digital signal which is converted in the converting unit to trace the target vehicle.

### CROSS-REFERENCE TO RELATED APPLICATIONS

The present application claims priority to Korean Patent Application Number 10-2014-0184736 filed Dec. 19, 2014, the entire contents of which application is incorporated herein for all purposes by this reference.

### TECHNICAL FIELD

The present invention relates to a radar system for a vehicle and an operating method thereof, and particularly, to a radar system for a vehicle which dynamically varies a waveform within a variable detection distance range depending on presence of a target vehicle and a position to detect a target and an operating method thereof.

### BACKGROUND

Recently, there is a trend to mount an auxiliary system which assists a driver to drive a vehicle and provides various information for convenience of a driver in a vehicle. Among the auxiliary systems, a radar device is mounted as a device for detecting a target vehicle or a target object.

As disclosed in Korean Unexamined Patent Application Publication No. 10-1998-067828A, a detection distance and distance resolution changeable device in accordance with far, intermediate, and close modes of a vehicle is suggested as a device of detecting a target according to the related art. The device detects a distance from the target.

Korean Unexamined Patent Application Publication No. 10-2012-0106567A discloses a radar device which simultaneously supports short distance and long distance radar functions.

In the case of long distance detection, as compared with short distance detection, the radar device has a longer detection distance and a narrower detecting angle, and better resolution for the detecting angle. Further, in the case of short distance detection, as compared with the long distance detection, the radar device has a shorter detection distance, a wider detecting angle, and more excellent resolution for the detection distance.

However, in Korean Unexamined Patent Application Publication No. 1998-067828A, a Chirp which has different slopes depending on each mode of a close, intermediate, or far distance is used to slightly vary importance of target information which is detected in each mode and in Korean Unexamined Patent Application Publication No. 10-2012-0106567A, close distance target information and far distance target information are simultaneously detected.

In both technologies, one Chirp is used in each mode and the Chirp is designed to be focused on an interest detection distance and has a fixed waveform so that the Chirp operates regardless of presence of a target to follow and a distance. Therefore, there is a limitation on radar recognizing performance.

A performance is significantly lowered due to signal interference of a surrounding environment.

As a result, a method which more efficiently detects a target is required.

### SUMMARY

The present invention has been made in an effort to provide a radar system for a vehicle which dynamically modifies a waveform within a demanded detecting range which varies depending on whether there is a target fixed to follow to have a maximum distance resolution, thereby improving a detecting performance, and an operating method thereof.

An exemplary embodiment of the present invention provides a radar system for a vehicle, including: a radar which is located around a driver's vehicle (hereinafter, referred to as a principal vehicle) to detect a target vehicle which threatens the driving of the principal vehicle as a target, in which the radar includes: a transmission antenna which transmits a signal for detecting the target vehicle; a reception antenna which receives a reflective signal for the transmitted signal; a communication module which transmits a high frequency signal through the transmission antenna; a converting unit which converts the reception signal which is received through the reception antenna into a digital signal; and a signal processing unit which generates a detection signal to detect the target vehicle, in accordance with a speed, a yaw rate of the principal vehicle and the digital signal, applies the detection signal to the communication module, and analyzes the digital signal which is converted in the converting unit to trace the target vehicle.

The signal processing unit may calculate a trace of the principal vehicle, a target threatening degree of the target vehicle, and an effective distance to detect and trace the target vehicle based on the detection signal and the digital signal.

The signal processing unit may calculate the target threatening degree based on whether the target vehicle is in the same lane as the lane of the principal vehicle, a distance between the principal vehicle and the target vehicle, and a relative speed with respect to the target vehicle.

The signal processing unit may control a transmitting time of the detection signal in accordance with the operating cycle of the radar.

The signal processing unit may model a surrounding environment of the vehicle and change the detection signal at a low resolution and a high resolution to transmit the detection signal.

Another exemplary embodiment of the present invention provides an operating method of a radar system for a vehicle, comprising: transmitting a signal for detecting a target vehicle which threatens a vehicle through a transmission antenna of a radar; receiving a reflection signal for the transmitted signal through a reception antenna; transmitting, by a communication module, a high frequency signal through the transmission antenna; converting, by the converting unit, the reception signal which is received through the reception antenna into a digital signal; generating a detection signal for detecting the target vehicle in accordance with a speed, a yaw rate of the principal vehicle, and the digital signal to apply the detection signal to the communication module; and calculating, by a signal processing unit, a trace of the principal vehicle, a target threatening degree of the target vehicle, and an effective detection distance based on the detection signal and the digital signal to detect and trace the target vehicle.

According to the radar system for a vehicle and an operating method thereof according to the present invention, a waveform having an optimal resolution within a demanded detecting range varying depending on presence of a target vehicle which becomes a following target of a radar and a position thereof is dynamically operated. Therefore, a signal interference due to surrounding environment is minimized, thereby improving stability of tracing a target to prevent loss of a target, detecting delay, erroneous recognition, significantly improving tracing performance, obtaining more precise information through high resolution for the following target to improve stability in controlling to drive a vehicle.

In accordance with a speed of the principal vehicle, a yaw rate, and a converted digital signal, a target vehicle which threatens the principal vehicle is traced so that a waveform of a detection signal is optimized in accordance with the traced target vehicle and a ultrahigh frequency signal is generated and radiated in accordance with the optimized waveform to more precisely and stably recognize other vehicles near the principal vehicle.

### BRIEF DESCRIPTION OF THE DRAWINGS

FIG. 1 is a block diagram illustrating a configuration of a radar system for a vehicle according to an exemplary embodiment of the present invention.

FIG. 2 is a view explaining a method of measuring a trace of a principal vehicle by a radar system for a vehicle according to an exemplary embodiment of the present invention.

FIG. 3 is an exemplary view illustrating an exemplary embodiment of an operation depending on presence and a position of a target vehicle which is a following target of a radar system for a vehicle according to an exemplary embodiment of the present invention.

FIG. 4 is a flowchart illustrating an operating method of a radar system for a vehicle according to an exemplary embodiment of the present invention.

FIG. 5 is an exemplary view illustrating an exemplary embodiment of environmental modeling in accordance with surrounding environment detection of a radar system for a vehicle according to an exemplary embodiment of the present invention.

FIG. 6 is an exemplary view illustrating an exemplary embodiment of low resolution detection in accordance with surrounding environment detection of a radar system for a vehicle according to an exemplary embodiment of the present invention.

FIG. 7 is an exemplary view illustrating an exemplary embodiment of high resolution detection in accordance with surrounding environment detection of a radar system for a vehicle according to an exemplary embodiment of the present invention.

### DETAILED DESCRIPTION

Advantages and characteristics of the present invention and a method of achieving the advantages and characteristics will be clear by referring to exemplary embodiments described below in detail together with the accompanying drawings. However, the present invention is not limited to the exemplary embodiment disclosed herein but will be implemented in various forms. The exemplary embodiments are provided to enable the present invention to be completely disclosed and the scope of the present invention to be easily understood by those skilled in the art. Therefore, the present invention will be defined only by the scope of the appended claims. Like reference numerals indicate like elements throughout the specification.

Hereinafter, exemplary embodiments of the present invention will be described in detail with reference to the accompanying drawings as follows.

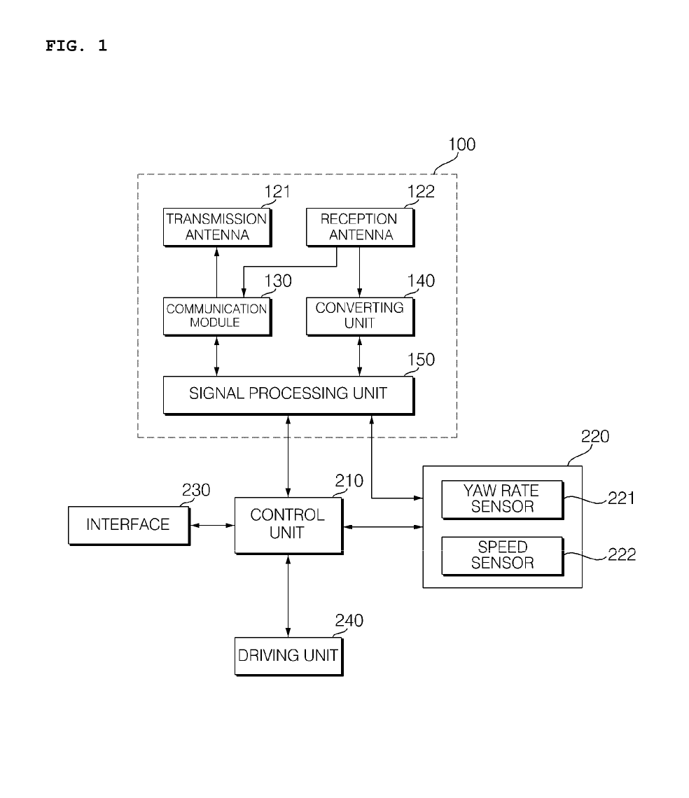

FIG. 1 is a block diagram illustrating a configuration of a radar system for a vehicle according to an exemplary embodiment of the present invention.

A radar system for a vehicle according to an exemplary embodiment of the present invention includes a radar 100, a transmission antenna 121, a reception antenna 122, a communication module 130, a converting unit 140, and a signal processing unit 150, as illustrated in FIG. 1.

The vehicle includes a sensor unit 220 which detects a vehicle driving state, a driving unit 240, an interface 230, and a control unit 210 which controls an entire operation of the vehicle. In this case, the sensor unit 220 includes a yaw rate sensor 221 and a speed sensor 222.

The vehicle includes a component such as an engine, a motor, or a transmission for driving a vehicle and the sensor unit 220 further includes a plurality of sensors, but the description thoseof will be omitted below.

The interface 230 of the vehicle includes an input unit (not illustrated) including a plurality of switches which inputs a predetermined signal by manipulation of a driver and an output unit (not illustrated) which outputs information while the vehicle operates in a current state. Further, the interface 230 includes a manipulating unit for driving such as a steering wheel, an accelerator, and a brake.

The input unit includes a plurality of switches or buttons for operation of a turn signal lamp, a tail lamp, a head lamp, and a brush in accordance with the driving of the vehicle. The output unit includes a display unit which displays information, a speaker which outputs music, sound effect, and alarm, an instrument panel of the vehicle, and various indicator lights. The output unit outputs status information on overall current operations of the vehicle such as speed information or lamp lighting situation. Specifically, the output unit outputs a warning when an unusual situation occurs in the vehicle and outputs a predetermined image through the display unit. In this case, the warning of the vehicle may be output as at least one of a warning sound or voice warning, a warning light, a warning message, and a warning image.

Operation data in accordance with the operating of the vehicle, reference data to determine whether the vehicle abnormally operates, and data which is generated while the vehicle is driven are stored in a data unit (not illustrated).

The driving unit 240 controls each component of the vehicle to operate in accordance with input by the manipulating unit of the interface 230 and a control command of the control unit 210, so that the vehicle moves to be driven in accordance with the manipulation of the driver. The driving unit 240 directly controls driving of vehicle components such as an engine, a transmission, and a brake in accordance with the control command.

The control unit 210 controls a predetermined lamp to be turned on in accordance with switch manipulation of the interface 230, controls a turn signal lamp to be turned on and turned off, and controls a vehicle speed to accelerate or decelerate the vehicle in accordance with the operation of the accelerator or the brake.

The control unit 210 detects abnormality of the vehicle and outputs a warning in accordance with the abnormality through the output unit of the interface 230. Further, the control unit 210 applies the control command to the driving unit 240 in accordance with a driving status of the vehicle detected by the sensor unit 220 to move the vehicle.

In the meantime, the radar 100 detects a target vehicle and inputs a detection result to the control unit 210.

The transmission antenna 121 transmits a signal for detecting a target vehicle. The transmission antenna 121 transmits a waveform formed in the communication module 130 in the form of an electromagnetic wave in accordance with a designed antenna radiation pattern.

The reception antenna 122 receives a reflection signal with respect to the transmitted signal. The reception antenna 122 receives a transmission waveform reflected from the target.

The communication module 130 is an RF module and generates an ultrahigh frequency signal in accordance with the control of the signal processing unit 150.

The communication module 130 transmits the ultrahigh frequency signal through the transmission antenna. The communication module 130 divides the generated ultrahigh frequency signal into a transmitting signal and an LO signal which is a hand signal reference signal through self-reference to be transmitted through a switch. The communication module 130 transmits the transmitting signal to the transmission antenna 121 and the receiving reference signal to a mixer of the communication module 130 to perform transmission/reception self-reference in a multi-reception channel, convert the ultrahigh frequency wave into a baseband signal, and output the converted baseband signal.

The converting unit 140 receives the reception signal which is converted into the baseband signal through the self-reference in the communication module 130. The converting unit 140 performs digital conversion to convert a reception signal received through the reception antenna into a digital signal in accordance with the control of the signal processing unit 150.

The converting unit 140 does not divide the digital signal into a real signal and an image signal, but outputs only a quantized signal for a real signal. Therefore, the converting unit 140 minimizes an operating load.

The signal processing unit 150 includes software for signal operation and calculates a trace of the principal vehicle, a target threatening degree of the target vehicle, and an effective distance to detect the target vehicle based on received data and inputs the result in the control unit 210.

The control unit 210 determines whether the target vehicle interrupts a driver to drive the principal vehicle in accordance with the detecting result of the radar 100 and drives the vehicle in accordance with the determination.

In this case, the signal processing unit 150 performs signal operation through software and provides physical interfaces for the communication module 130, the converting unit 140, and the sensor unit 220 of the vehicle.

The signal processing unit 150 calculates a lane and a vehicle speed in accordance with the data input from the sensor unit 220.

The signal processing unit 150 obtains a yaw rate signal from the yaw rate sensor 221 of the sensor unit 220 at every 20 m/sec to perform filtering and calculates a yaw rate.

In this case, the signal processing unit 150 performs moving average filtering in order to remove a noise of data received from the yaw rate sensor 221.

The signal processing unit 150 receives speed information for a plurality of wheels of a vehicle from the speed sensor 222 and calculates an average of the speed information to calculate a speed of the principal vehicle. In this case, the signal processing unit 150 distinguishes all wheel control and rear wheel control in accordance with a control method of the vehicle to calculate an average of speed information. For example, in the case of a rear wheel control vehicle, an average of information of left and right wheels of the rear wheel is calculated to calculate a speed of the principal vehicle.

The signal processing unit 150 calculates a trace of the vehicle based on the calculated yaw rate and the speed of the vehicle.

The signal processing unit 150 analyzes a target threatening degree of the target vehicle.

The signal processing unit 150 performs signal processing and trace processing on the quantized target reception signal to obtain target information. In this case, the signal processing unit 150 determines whether the target vehicle is present in the same lane as the lane of the principal vehicle and a distance from the target vehicle to analyze the target threatening degree based on the distance and a relative speed with respect to the target vehicle.

In this case, the signal processing unit 150 classifies the target vehicle into a preferred following target and a collision risk target in accordance with a distance from a center of the lane of the principal vehicle at a horizontal axis, a distance from the principal vehicle at a vertical axis, and a relative speed and importance thoseof are calculated and represented as a probability.

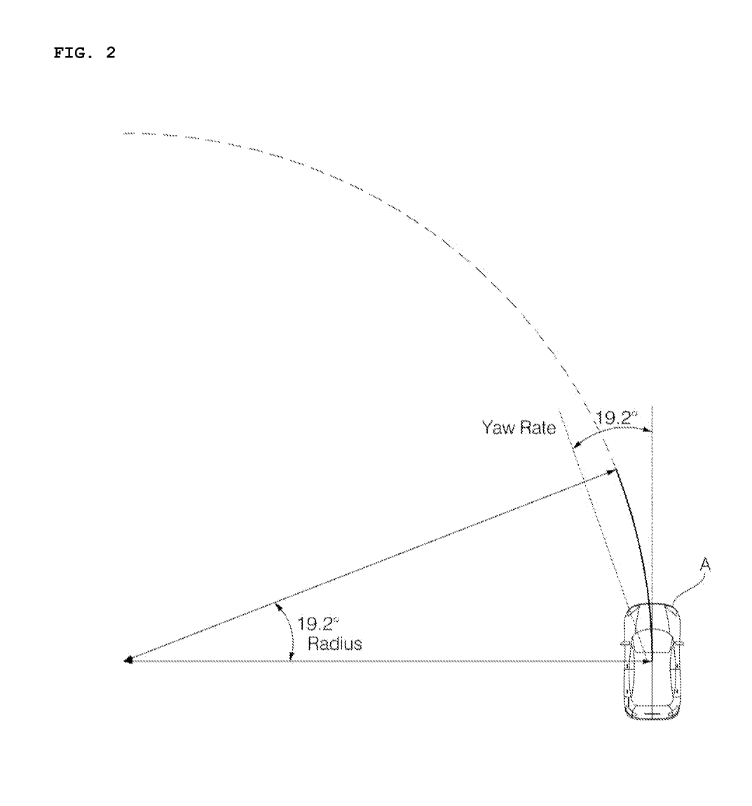

FIG. 2 is a view explaining a method of measuring a trace of a principal vehicle by a radar system for a vehicle according to an exemplary embodiment of the present invention. As illustrated in FIG. 2, a trace of the vehicle is calculated.

The signal processing unit 150 may divide the speed (ego speed) of the vehicle A by a yaw rate to estimate an advance steering angle (radius) of the vehicle.

In this case, the speed (speed of the principal vehicle) of the vehicle may be calculated as an average of the speed information for individual wheels input from the speed sensor 222 as described above and the yaw rate may be calculated based on the information input from the yaw rate sensor 221. In this case, the unit is degree/dT (angular speed).

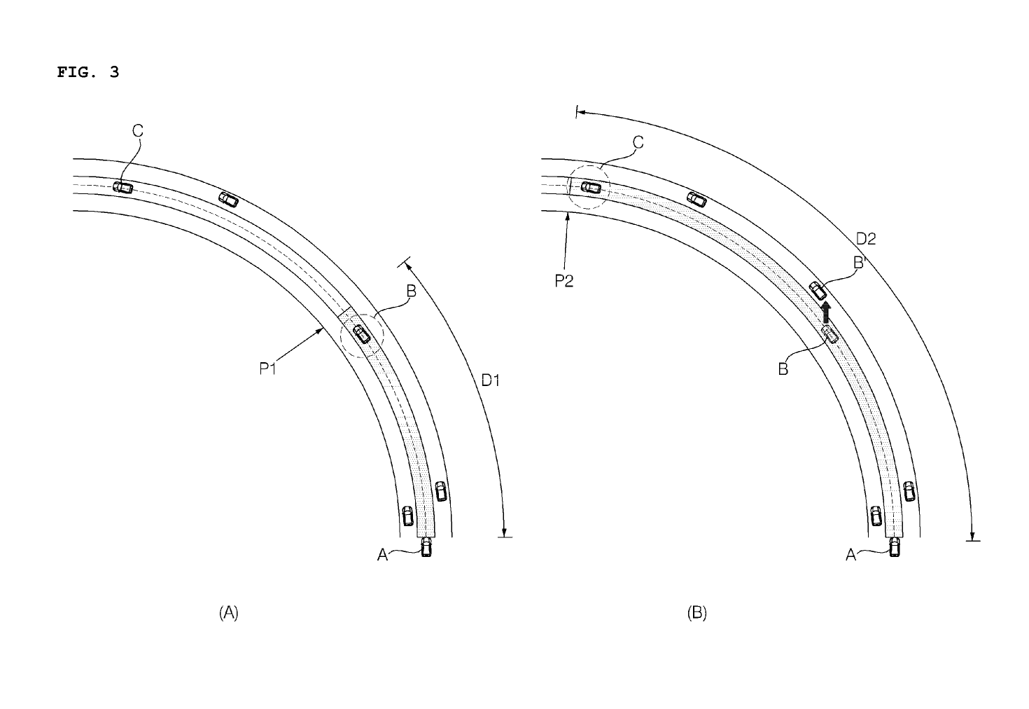

FIG. 3 is an exemplary view illustrating an exemplary embodiment of an operation depending on presence and a position of a target vehicle which is a following target of a radar system for a vehicle according to an exemplary embodiment of the present invention.

The signal processing unit 150 calculates an effective detection distance to detect a target vehicle.

When the target threatening degree is completely analyzed, the signal processing unit 150 calculates an effective detection distance based on the calculated probability of the preferred following target and the collision risk target.

In this case, the effective detection distance has an additional distance value in consideration of a distance from the principal vehicle to the target vehicle, a length of the vehicle, and a margin. Further, the effective detecting range is from the front edge (0 m) of the radar 100 of the principal vehicle to the effective detection distance in consideration of a Cut-in target at all times. When the probability of the preferred following target and the collision risk target is equal to or smaller than a predetermined value, that is, there is collision or following target, the signal processing unit 150 considers a maximum guarantee distance of the radar 100 as an effective distance. The effective distance is optimized by the following Equations 1 and 2.

BW=−([C·f]_bmax·τ)/2R Equation 1

f_fmax=f_s/2+(2·V_max)/λ Equation 2

In this case, C is a speed of light (3*10̂8 m.s), BW is a band width, fs is a sampling rate of the converting unit (ADC), Vmax is a requested maximum detecting speed, fbmax is a maximum beat frequency, λ is a wavelength, τ is a length of the waveform, and R is an effective distance.

When the effective detection distance is calculated by Equations 1 and 2 which have been described above, the signal processing unit 150 calculates an optimal waveform having the effective distance. Here, the waveform is a waveform for a signal which is transmitted through the transmission antenna 121 to detect the target and trace the target.

The signal processing unit 150 varies Vmax in consideration of the speed of the principal vehicle within the maximum guarantee speed of the radar sensor while calculating the optimal waveform. In this case, the length of the waveform has a static relative value by varying fs (ADS sampling rate). Further, a frequency bandwidth BW of the waveform is finally calculated by Equations 1 and 2. Due to characteristic of the FMCW waveform, the waveform is formed of a plurality of Chirps and individual Chirps are separately calculated in the order of the optimal waveform of the effective distance, change of Vmax in accordance with change of speed, setting of the length of the waveform, and calculating of a frequency bandwidth.

When there is no target vehicle, the signal processing unit 150 considers, as an effective distance, an intermediate distance region defined in order to check whether there is an undetected target due to environmental signal interference within a limit range which may reduce a speed or stop with reference to a braking performance of an SCC system and the waveform is calculated and stored at an initial driving timing. As illustrated in FIG. 3A, the radar 100 is located in the same lane (the lane of the principal vehicle) as the principal vehicle A and detects a target vehicle B which drives in front of the principal vehicle A.

In this case, the signal processing unit 150 calculates an effective distance D1 including a distance from the target vehicle B and a margin of the length of the vehicle based on input data. In this case, the effective distance is a distance to a first point P1 in consideration of the length of the target vehicle B and a margin from the vehicle A. As described above, the speeds of the principal vehicle A and the target vehicle are also considered.

As illustrated in FIG. 3B, when the target vehicle B which drives in the lane of the principal vehicle moves to a next lane (B′), a new target vehicle C is set.

As the target vehicle is changed, an effective distance is also changed.

In this case, a distance to a second point P2 is calculated as a new effective distance D2 in consideration of a distance to the new target vehicle C, a length of the new target vehicle C, and a margin.

In the meantime, the signal processing unit 150 performs scheduling on the waveform and resource management.

When the optical waveform is calculated as described above, the signal processing unit 150 applies the optimal waveform which is result data to the communication module 130 to transmit the optimal waveform through the transmission antenna 121. In this case, the signal processing unit 150 issues a control command in accordance with an operating cycle of the radar 100.

When there is no target vehicle, the signal processing unit 150 periodically alternately applies the static monitoring waveform based on the signal which is received through the reception antenna 122.

When an entire time of the waveform varies, the signal processing unit 150 performs resource management on the waveform generating time and the processing time in accordance with the radar sensor operating cycle to change the scheduling.

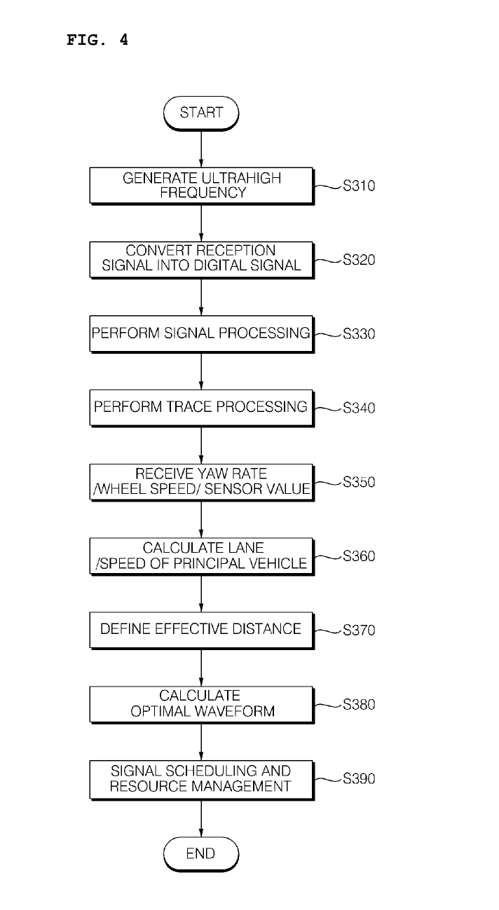

FIG. 4 is a flowchart illustrating an operating method of a radar system for a vehicle according to an exemplary embodiment of the present invention.

As illustrated in FIG. 4, the signal processing unit 150 applies a waveform for detecting a target vehicle to the communication module 130. The transmission antenna 121 transmits a signal to detect the target vehicle which threatens the principal vehicle. The reception antenna 122 receives a reflection signal with respect to the transmitted signal. The communication module 130 generates an ultrahigh frequency wave in accordance with the input waveform in step S310. The communication module 130 applies the ultrahigh frequency signal to the transmission antenna 121 to be transmitted. The communication module 130 divides the generated ultrahigh frequency signal into a transmitting signal and an LO signal which is a hand signal reference signal through self-reference to be transmitted through a switch. The communication module 130 transmits the transmitting signal to the transmission antenna 121 and the receiving reference signal to a mixer of the communication module 130 to perform transmission/reception self-reference in a multi-reception channel, convert the ultrahigh frequency wave into a baseband signal, and output the converted baseband signal.

The reception antenna 122 receives a reception signal corresponding to a transmitted signal to input the reception signal to the converting unit 140. That is, the converting unit 140 receives the reception signal which is converted into the baseband signal through the self-reference in the communication module 130.

The converting unit 140 converts the reception signal received through the reception antenna into a digital signal in step S320. The converting unit 140 converts the reception signal in step S320 to input the reception signal to the signal processing unit 150.

The signal processing unit 150 generates a detection signal to detect the target vehicle in accordance with a speed of the principal vehicle, a yaw rate, and a digital signal to apply the detection signal to the communication module 130. The signal processing unit 150 analyzes the reception signal to perform signal processing in step S330 and traces the target vehicle in step S340. The signal processing unit 150 calculates a trace of the principal vehicle, a target threatening degree of the target vehicle, an effective detection distance based on the detection signal an the digital signal to detect and trace the target vehicle in step S340. The signal processing unit 150 calculates the target threatening degree in consideration of a distance between the principal vehicle and the target vehicle, a relative speed with respect to the target vehicle, and whether the target vehicle is in the same lane as the lane of the principal vehicle.

The signal processing unit 150 receives a raw rate signal of the raw rate sensor 221 of the sensor unit 220 and speed information of the speed sensor 222 in step S350, calculates a steering angle of the vehicle based on the raw rate signal and the speed information, and calculates the speed of the vehicle in step S360.

The signal processing unit 150 calculates an effective distance to the target vehicle in step S370. As described above, the effective distance is set in consideration with the distance to the target vehicle, the length of the vehicle, and the margin. In this case, when the speeds of the vehicle and the target vehicle are changed, the effective distance may be changed.

The signal processing unit 150 generates an optimal waveform for tracing the target vehicle based on the previously calculated data in step S380. That is, the signal processing unit 150 optimizes the waveform of the detection signal for tracing the target vehicle corresponding to the speed of the principal vehicle, in accordance with the effective detection distance in step S380. When the effective detection distance is calculated by Equations 1 and 2, the signal processing unit 150 calculates an optimal waveform having the effective distance.

The signal processing unit 150 schedules the waveform in accordance with the operating cycle of the radar 100.

The communication module 130 generates an ultrahigh frequency signal in accordance with the scheduled waveform, by the control of the signal processing unit 150 to transmit the ultrahigh frequency signal through the transmission antenna 121.

The radar 100 detects and traces the target vehicle by repeating the above processes.

The control unit 210 controls the driving unit 240 to be driven based on the information of the target vehicle detected by the radar 100. Further, when the threatening degree by the target vehicle is increased, the control unit 210 controls the interface 230 to output a warning.

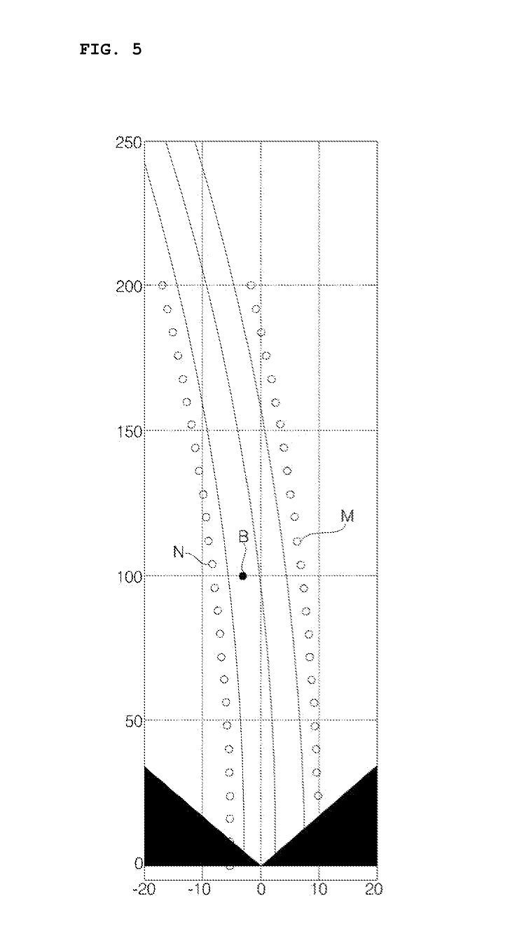

FIG. 5 is an exemplary view illustrating an exemplary embodiment of an environmental model in accordance with surrounding environment detection of a radar system for a vehicle according to an exemplary embodiment of the present invention.

As illustrated in FIG. 5, when the reception signal is input as a reflective signal for the transmitting signal, the radar 100 models the surroundings of the principal vehicle.

In this case, the radar 100 distinguishes lanes L1, L2, and L3 of the road and recognizes guard rail N and M. Further, the radar 100 calculates a driving angle as the vehicle is driven and detects the target vehicle B.

As described above, when the surrounding environment of the vehicle is modeled, the control unit 210 may output data through the output unit of the interface 230.

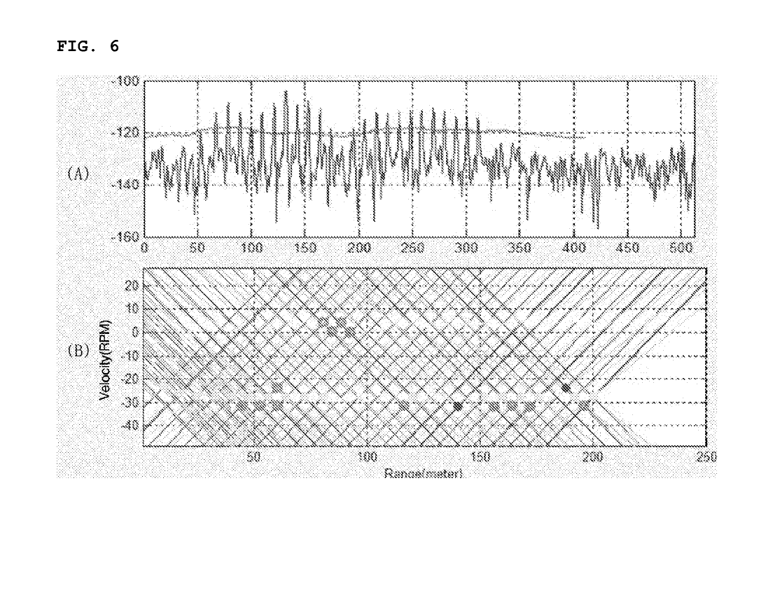

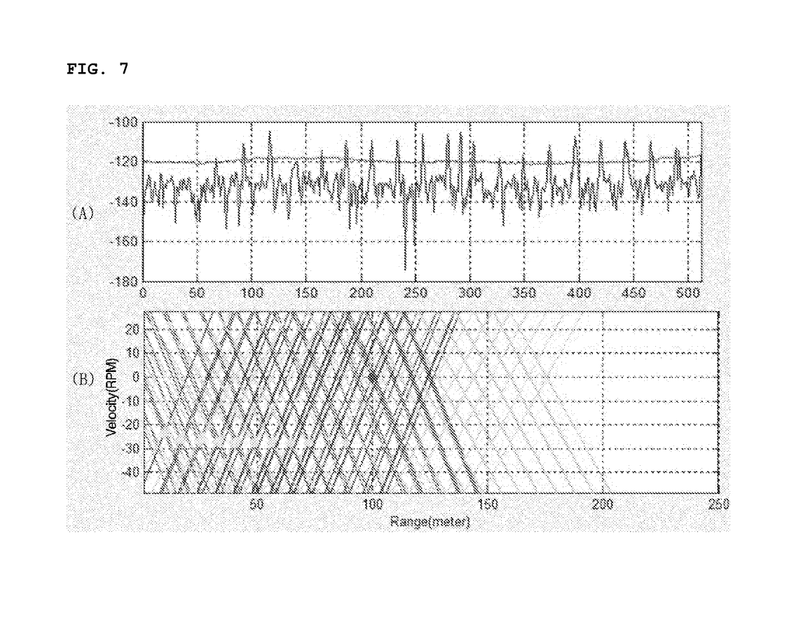

FIG. 6 is an exemplary view illustrating an exemplary embodiment of low resolution detection in accordance with surrounding environment detection of a radar system for a vehicle according to an exemplary embodiment of the present invention, and FIG. 7 is an exemplary view illustrating an exemplary embodiment of high resolution detection in accordance with surrounding environment detection of a radar system for a vehicle according to an exemplary embodiment of the present invention.

As illustrated in FIGS. 6 and 7, when the target vehicle is hardly detected due to the surrounding environment, the radar 100 detects the target vehicle through a low resolution waveform as illustrated in FIG. 6 and detects the target vehicle through a high resolution waveform as illustrated in FIG. 7.

As the radar 100 changes and transmits the detection signal in accordance with the surrounding environment so that the target vehicle may be precisely and easily detected and traced.

The word “comprise”, “configure”, or “have” used in the above description will be understood to imply the inclusion of stated elements unless explicitly described to the contrary, so that the word will be interpreted to imply the inclusion of stated elements but not the exclusion of any other elements.

Preferred embodiments of the present invention have been illustrated and described above, but the present invention is not limited to the above-described specific embodiments, it is obvious that various modifications may be made by those skilled in the art, to which the present invention pertains without departing from the gist of the present invention, which is claimed in the claims, and such modifications should not be individually understood from the technical spirit or prospect of the present invention.

What is claimed is:

1. A radar system for a vehicle, comprising:
a radar which is located around the principal vehicle to detect a target vehicle which threatens driving of the principal vehicle as a target,
wherein the radar includes:
a transmission antenna which transmits a signal for detecting the target vehicle;
a reception antenna which receives a reflective signal for the transmitted signal;
a communication module which transmits a high frequency signal through the transmission antenna;
a converting unit which converts the reception signal which is received through the reception antenna into a digital signal; and
a signal processing unit which generates a detection signal to detect the target vehicle, in accordance with a speed, a yaw rate of the principal vehicle and the digital signal, applies the detection signal to the communication module, and analyzes the digital signal which is converted in the converting unit to trace the target vehicle.

2. The radar system of claim 1, wherein the communication module generates an ultrahigh frequency signal in accordance with the control of the signal processing unit, divides the ultrahigh frequency into a transmitting signal and a reception reference signal through self-reference to apply the transmitting signal to the transmission antenna and performs the transmission and reception self-reference on the reception reference signal in a multi reception channel through a mixer to convert and output the ultrahigh frequency signal into a baseband signal.

3. The radar system of claim 1, wherein the converting unit does not divide the digital signal into a real signal and an image signal, but outputs only a quantized signal for the real signal.

4. The radar system of claim 1, wherein the signal processing unit calculates a trace of the principal vehicle, a target threatening degree of the target vehicle, and an effective distance to detect and trace the target vehicle based on the detected signal and the digital signal.

5. The radar system of claim 4, wherein the signal processing unit calculates the target threatening degree based on whether the target vehicle is in the same lane as the lane of the principal vehicle, a distance between the principal vehicle and the target vehicle, and a relative speed with respect to the target vehicle.

6. The radar system of claim 5, wherein the signal processing unit classifies the target vehicle into a preferred following target and a collision risk target in accordance with a distance from a center of the lane of the principal vehicle at a horizontal axis, a distance from the principal vehicle at a vertical axis, and a relative speed and calculates importance thoseof as a probability to calculate the target threatening degree.

7. The radar system of claim 6, wherein when the target threatening degree is completely analyzed, the signal processing unit sets the target vehicle based on the calculated probability of the preferred following target and the collision risk target and calculates the effective detection distance of the target vehicle.

8. The radar system of claim 7, wherein when the probability of the preferred following target and the collision risk target is equal to or smaller than a predetermined value, the signal processing unit determines that there is no collision or following target, to set a previously set maximum guarantee distance as the effective detection distance.

9. The radar system of claim 4, wherein the signal processing unit divides the speed (ego speed) of the principal vehicle by the yaw rate to calculate an advance steering angle (radius) of the principal vehicle and measures the trace of the principal vehicle by the calculated advance steering angle.

10. The radar system of claim 9, wherein the signal processing unit receives speed information of a plurality of wheels of the vehicle from a speed sensor provided in the vehicle and calculates an average of the plurality of speed information to calculate the speed of the vehicle.

11. The radar system of claim 9, wherein the signal processing unit receives the yaw rate signal from a yaw rate sensor provided in the vehicle at every 20 m/sec and removes noise by performing moving average filtering on the yaw rate signal to calculate the yaw rate.

12. The radar system of claim 4, wherein the signal processing unit calculates the effective detection distance based on the distance from the vehicle to the target vehicle, a length of the target vehicle, and a margin.

13. The radar system of claim 12, wherein the signal processing unit optimizes a waveform of the detection signal for detecting the target vehicle in consideration of the speed of the principal vehicle, in accordance with the effective detection distance.

14. The radar system of claim 1, wherein the signal processing unit controls a transmitting time of the detection signal in accordance with an operating cycle of the radar.

15. The radar system of claim 1, wherein the signal processing unit models a surrounding environment of the vehicle and changes the detection signal at a low resolution and a high resolution to transmit the detection signal.

16. An operating method of a radar system for a vehicle, comprising:
transmitting a signal for detecting a target vehicle which threatens the principal vehicle through a transmission antenna of a radar;
receiving a reflection signal for the transmitted signal through a reception antenna of the radar;
transmitting, by a communication module, a high frequency signal through the transmission antenna;
converting the reception signal which is received through the reception antenna into a digital signal;
generating a detection signal for detecting the target vehicle in accordance with a speed, a yaw rate of the principal vehicle, and the digital signal to apply the detection signal to the communication module; and
calculating a trace of the principal vehicle, a target threatening degree of the target vehicle, and an effective detection distance based on the detection signal and the digital signal to detect and trace the target vehicle.

17. The method of claim 16, wherein the target threatening degree is calculated based on a distance between the principal vehicle and the target vehicle, a relative speed with respect to the target vehicle, and whether the target vehicle is in the same lane as the lane of the principal vehicle.

18. The method of claim 16, further comprising:
receiving a yaw rate signal and speed information; and
calculating a steering angle and a speed of the vehicle based on the yaw rate signal and the speed information.

19. The method of claim 18, further comprising:
classifying the target vehicle into a preferred following target and a collision risk target in accordance with a distance from a center of the lane of the principal vehicle at a horizontal axis, a distance from the principal vehicle at a vertical axis, and a relative speed; and
when the probability of the preferred following target and the collision risk target is equal to or smaller than a predetermined value, determining that there is no collision or following target, to set a previously set maximum guarantee distance as the effective detection distance.

20. The method of claim 19, further comprising:
optimizing a waveform of the detection signal for tracing the target vehicle in accordance with the speed of the principal vehicle, corresponding to the effective detection distance; and
scheduling the waveform in accordance with an operating cycle of a radar and generating an ultrahigh frequency signal in accordance with the scheduled waveform to transmit the ultrahigh frequency signal.
